(19) United States
(12) Patent Application Publication
(10) Pub. No.: US 2025/0099912 A1
(43) Pub. Date: Mar. 27, 2025

(54) MASS TRANSFER ASSEMBLIES WITH HEAT SINK AIR CHANNELS

(71) Applicant: Alliance for Sustainable Energy, LLC, Golden, CO (US)

(72) Inventor: Eric KOZUBAL, Superior, CO (US)

(21) Appl. No.: 18/890,990

(22) Filed: Sep. 20, 2024

Related U.S. Application Data
(60) Provisional application No. 63/584,433, filed on Sep. 21, 2023.

(51) Int. Cl. B01D 53/26; F28D 21/00

(52) U.S. Cl. CPC B01D 53/263; F28D 21/0015; B01D 2257/80; B01D 2258/06; B01D 2259/4508; F28D 2021/0038

(57) ABSTRACT

The disclosure relates to parallel plate assemblies for heat exchangers. In some examples, a plate assembly includes a first plate. The first plate includes a first side that defines a side of a conditioning channel. In addition, the conditioning channel is configured to receive a flow of process air from a first end of the plate assembly and output a flow of conditioned air from a second end of the plate assembly. The first plate also includes a second side, opposite the first side, that defines a side of an exhaust channel. The exhaust channel is configured to receive a flow of heat sink air and at least a portion of the flow of conditioned air, and output a flow of exhaust air.

### CROSS-REFERENCE TO RELATED APPLICATION

This application claims the benefit of priority to U.S. Provisional Patent Application No. 63/584,433, filed on Sep. 21, 2023, the entire disclosure of which is expressly incorporated herein by reference to its entirety.

### CONTRACTUAL ORIGIN

This invention was made with government support under Contract No. DE-AC36-08GO28308 awarded by the Department of Energy. The government has certain rights in this invention.

### TECHNICAL FIELD

The disclosure relates generally to heat exchangers for heating, ventilation, and air conditioning systems and, more particularly, to mass transfer assemblies for heat exchangers.

### BACKGROUND

Heating, ventilation, and air conditioning (HVAC) systems generally cool ambient or room temperature air using a vapor compression refrigeration cycle. The HVAC systems may cool the ambient or room temperature air by removing heat using a refrigerant. Less frequently, the HVAC systems may employ a liquid desiccant to dehumidify the air during the cooling process. Further, the HVAC systems may include a heat exchanger that operates to remove the heat from the refrigerant. For example, the heat exchanger may include plates or coils through which the refrigerant flows. A fan may blow air across the plates or coils to cool the refrigerant flowing within.

### SUMMARY

In some examples, a plate assembly includes a first plate. The first plate includes a first side that defines a side of a conditioning channel. In addition, the conditioning channel is configured to receive a flow of process air from a first end of the plate assembly and output a flow of conditioned air from a second end of the plate assembly. The first plate also includes a second side, opposite the first side, that defines a side of an exhaust channel. The exhaust channel is configured to receive a flow of heat sink air and at least a portion of the flow of conditioned air, and output a flow of exhaust air.

In some examples, an apparatus includes a first plate assembly and a second plate assembly. The first plate assembly includes a first plate. The first plate includes a first side that defines a side of a first conditioning channel. The first conditioning channel is configured to receive a first flow of process air from a first end of the first plate assembly, and output a first flow of conditioned air from a second end of the first plate assembly. In addition, the first plate assembly is configured to output a first portion of the first flow of conditioned air as supply air to a building. The first plate also includes a second side, opposite the first side, that defines a side of a first exhaust channel. The first exhaust channel is configured to receive a first flow of heat sink air and at least a second portion of the flow of conditioned air, and output a first flow of exhaust air. Further, the second plate assembly includes a second plate. The second plate includes a first side that defines a side of a second conditioning channel. The second conditioning channel is configured to receive a second flow of process air and output a second flow of conditioned air. The second plate also includes a second side, opposite the first side, that defines a side of a second exhaust channel.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description.

FIG. 1 illustrates a plate assembly, in accordance with some embodiments;

FIG. 2 illustrates a plate assembly, in accordance with some embodiments;

FIG. 3 illustrates a liquid desiccant air conditioning system, in accordance with some embodiments;

FIG. 4 illustrates a plate assembly, in accordance with some embodiments; and

FIG. 5 illustrates a plate assembly, in accordance with some embodiments.

### DETAILED DESCRIPTION

The following discussion omits or only briefly describes conventional features of heat and mass exchangers that are apparent to those skilled in the art. It is noted that various embodiments are described in detail with reference to the drawings, in which like reference numerals represent like parts and assemblies throughout the several views. Reference to various embodiments does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations.

Unless otherwise specifically defined herein, all terms are to be given their broadest reasonable interpretation including meanings implied from the specification as well as meanings understood by those skilled in the art and/or as defined in dictionaries, treatises, etc. It must also be noted that, as used in the specification and the appended claims, the singular forms “a,” “an” and “the” include plural referents unless otherwise specified, and that the terms “includes” and/or “including,” when used in this specification, specify the presence of stated features, elements, and/or components, but do not preclude the presence or addition of one or more other features, steps, operations, elements, components, and/or groups thereof. In the description, relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms including “above” versus “below,” “inwardly” versus “outwardly,” “longitudinal” versus “lateral,” and the like are to be interpreted relative to one another or relative to an axis of elongation, or an axis or center of rotation, as appropriate. Terms concerning attachments, coupling, and the like, such as “connected” and “interconnected,” refer to a relationship wherein structures are secured or attached to one another either directly or indirectly through intervening structures, as well as both movable or rigid attachments or relationships, unless expressly described otherwise. The terms “operatively connected,” “operably connected,” and the like are such attachments, couplings, or connections that allow the pertinent structures to operate as intended by virtue of that relationship.

Embodiments of the present disclosure relate generally to heat exchangers and, more particularly, to parallel plate heat exchangers that facilitate the flow of multiple fluids to transfer heat from a fluid, such as water, refrigerant, glycol, or liquid desiccant. Examples of assemblies for parallel plate heat exchangers are provided in U.S. patent application Ser. No. 18/654,640, filed May 3, 2024, the contents of which are hereby incorporated by reference in their entirety. The flow of multiple fluids may include flows in different phases. For instance, one flow may be in gas form (e.g., air flow), and another flow may be in liquid form (e.g., water flow), with both flows participating in the heat transfer process. For instance, the two flows (e.g., external flows) may operate to remove heat from a third flow (e.g., an internal flow), such as water, refrigerant, glycol, or liquid desiccant. In some examples the flows may mix, at least partially, before or after traversing through a parallel plate heat exchanger.

In some examples, embodiments may include a plate assembly that includes a first side that is opposite to a second side. The first side defines a side of a conditioning channel, while the second side defines a side of an exhaust channel. A first fluid flow, such as a flow of process air, may enter the conditioning channel from a first end of the plate assembly, and a flow of conditioned air may exit the conditioning channel from a second end of the plate assembly. Further, a flow of heat sink air, which can be a portion of the flow of conditioned air and/or a portion of the process air, enters the exhaust channel, and a flow of exhaust air exits the exhaust channel. The flow of heat sink air may facilitate the transfer of heat out of the process air or desiccant in the conditioning channel, either by convection directly or, for instance, by facilitating the evaporation of water in the exhaust channel.

In some examples, the plate assembly bifurcates a flow of outside air to provide the flow of process air and the flow of heat sink air. In some examples, the flow of heat sink air enters the exhaust channel from the first end of the plate assembly. Additionally or alternatively, in some examples, at least a portion of the flow of conditioned air exiting the conditioning channel enters the exhaust channel as a flow of heat sink air. This flow of heat sink air may enter the exhaust channel from the second end of the plate assembly. Further, in some examples, the flow of exhaust air may exit the exhaust channel from the first end of the plate assembly.

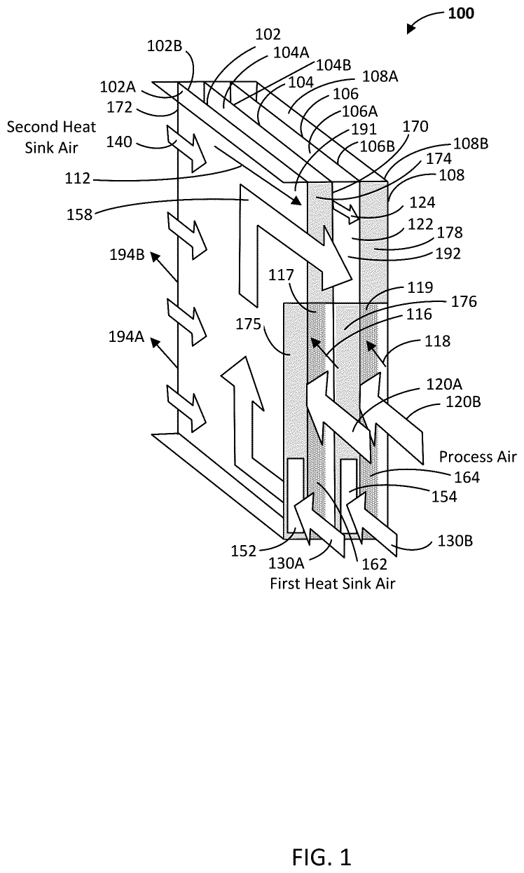

Referring to the drawings, FIG. 1 illustrates a plate assembly 100 that includes a first plate 102, a second plate 104, a third plate 106, and a fourth plate 108. A first side 102A of the first plate 102 defines a first side of a first exhaust channel 112, and a second side 102B of the first plate 102 defines a first side of a first conditioning channel 116. Further, a first side 104A of the second plate 104 defines a second side of the first conditioning channel 116, and a second side 104B of the second plate 104 defines a first side of a second exhaust channel 122. Likewise, a first side 106A of the third plate 106 defines a second side of the second exhaust channel 122, and a second side 106B of the third plate 106 defines a first side of a second conditioning channel 118. Further, a first side 108A of the fourth plate 108 defines the second side of the second conditioning channel 118. The second side 108B of the fourth plate 108 can define a side of another exhaust channel.

In this example, at least a portion of a flow of process air (i.e., first flow of process air 120A, second flow of process air 120B) is received into each of the first conditioning channel 116 and second conditioning channel 118 at a first end 170 of the plate assembly 100. The flow of process air 120A, 120B may be, for example, outside air. Specifically, the first flow of process air 120A may be received into a first process air opening 117 of the plate assembly 100. The first process air opening 117 may be defined, at least in part, by the second side 102B of the first plate 102, the first side 104A of the second plate 104, and a first process air barrier 174. The first flow of process air 120A may be dehumidified and/or cooled as it proceeds through the first conditioning channel 116. For example, and as described herein, each conditioning channel may include a dehumidification stage and a cooling stage. For instance, a dehumidification stage of the first conditioning channel 116 may include wicking material 162 along the side surfaces of the first conditioning channel 116. The plate assembly 100 may be configured to provide a heat transfer fluid, such as water, refrigerant, glycol, or liquid desiccant, to the wicking material 162 to dehumidify the first flow of process air 120A. Further, a cooling stage of the first conditioning channel 116, which may be downstream of the dehumidification stage, may be configured to cool the first flow of process air 120A. The dehumidified and cooled air may exit the first conditioning channel 116 at a second end 172 of the plate assembly 100 as first supply air 194A. The first supply air 194A may be provided, for example, to a building.

Similarly, the second flow of process air 120B may be received into a second process air opening 119 of the plate assembly 100. The second process air opening 119 may be defined, at least in part, by the second side 106B of the third plate 106, the first side 108A of the fourth plate 108, and a second process air barrier 178. The second flow of process air 120B may be dehumidified and/or cooled as it proceeds through the second conditioning channel 118. For instance, a dehumidification stage of the second conditioning channel 118 may include wicking material 164 along the side surfaces of the second conditioning channel 118. The plate assembly 100 may be configured to provide a heat transfer fluid, such as liquid desiccant, to the wicking material 164 to dehumidify the second flow of process air 120B. Further, a cooling stage of the second flow of process air 120B, which may be downstream of the dehumidification stage, may be configured to cool the second flow of process air 120B. The dehumidified and cooled air may exit the second conditioning channel 118 at the second end 172 of the plate assembly 100 as second supply air 194B. The second supply air 194B may be provided, for example, to the building.

In addition, a first flow of heat sink air 130A is received into the first exhaust channel 112, and a second flow of heat sink air 130B is received into the second exhaust channel 122. More specifically, the first flow of heat sink air 130A is received into a first heat sink air opening 152 of an exhaust air barrier 175 of the plate assembly 100. In addition, the second flow of heat sink air 130B is received into a second heat sink air opening 154 of a second exhaust air barrier 176 of the plate assembly 100. Each of the first flow of heat sink air 130A and second flow of heat sink air 130B may be, for example, a flow of outside air. As illustrated, the first flow of heat sink air 130A enters the first exhaust channel 112 at the first end 170 of the plate assembly 100, and may assist in absorbing heat from the first conditioning channel 116. After proceeding through at least portions of the first exhaust channel 112, the first flow of heat sink air 130A may form at least part of a first flow of exhaust air 158 that exits the first exhaust channel 112 at the first end 170 of the plate assembly 100 through a first exhaust channel opening 191.

Similarly, the second flow of heat sink air 130B that enters the second heat sink air opening 154 enters the second exhaust channel 122 at the first end 170 of the plate assembly, and may assist in absorbing heat from the first conditioning channel 116 and/or the second conditioning channel 118. After proceeding through at least portions of the second exhaust channel 122, the second flow of heat sink air 130B may form at least part of a second flow of exhaust air 124 that exits the second exhaust channel 122 through a second exhaust channel opening 192. The second exhaust channel opening 192 may be defined, at least in part, by the second side 104B of the second plate 104, the first side 106A of the third plate 106, and the second exhaust air barrier 176.

As illustrated, in some instances, a second flow of heat sink air 140 enters the first exhaust channel 112 from the second end 172 of the plate assembly 100. The second flow of heat sink air 140 may be a portion of the first supply air 194A and/or the second supply air 194B exiting the first and second conditioning channels 116, 118. In some instances, the second flow of heat sink air 140 mixes (e.g., combines) with the first flow of heat sink air 130A. As such, the mixed flows may remove heat from the first conditioning channel 116, and may exit the first exhaust channel 112 as the first flow of exhaust air 158. Similarly, the second flow of heat sink air 140 may enter the second exhaust channel 122 from the second end 172 of the plate assembly 100, and may form at least part of the second flow of exhaust air 124.

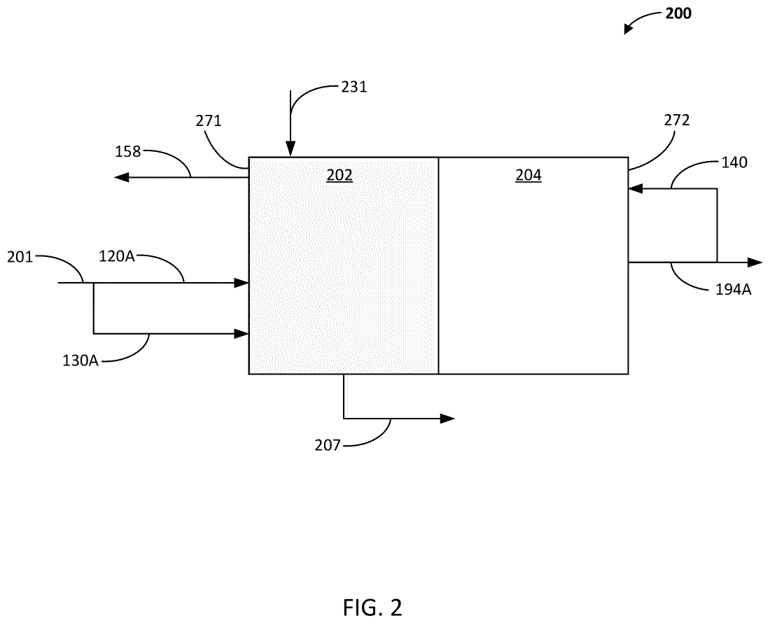

FIG. 2 illustrates a plate assembly 200 that includes one or more conditioning channels each with a dehumidification stage 202 and a cooling stage 204, and one or more exhaust channels. In this example, a flow of outside air 201 is bifurcated to a flow of process air 120A and a first flow of heat sink air 130A. The flow of process air 120A enters a conditioning channel of the plate assembly 200 from a first end 271 of the plate assembly 200 and is dehumidified during the dehumidification stage 202. For example, a heat transfer fluid, such as concentrated liquid desiccant 231, may be provided to wicking material positioned along the surfaces of the dehumidification stage of the conditioning channel to dehumidify the flow of process air 120A. The concentrated liquid desiccant 231 may flow down through the wicking material thereby dehumidifying the flow of process air 120A as it proceeds through the conditioning channel. The plate assembly 200 may provide the now diluted liquid desiccant 207 for re-concentration. The flow of process air 120A continues to flow through the conditioning channel and is cooled during the cooling stage 204, which may be downstream of the dehumidification stage 202. The dehumidified and cooled flow may exit the conditioning channel at a second end 272 of the plate assembly as supply air 194A.

Further, the first flow of heat sink air 130A enters an exhaust channel of the plate assembly 200 from the first end 271 and, after proceeding through at least portions of the exhaust channel thereby removing heat from the flow of process air 120A within the conditioning channel, exits the exhaust channel from the first end 271 of the plate assembly 200 as a flow of exhaust air 158. As such, while first flow of heat sink air 130A enters the exhaust channel in a same direction as the flow of the process air 120A enters the conditioning channel, the flow of exhaust air 158 may exit the exhaust channel in a direction opposite from which the flow of the process air 120A and/or the first flow of heat sink air 130A enter their respective channels.

In some examples, at least a portion of the supply air 194A is provided as a second flow of heat sink air 140 to one or more exhaust channels. For instance, the second flow of heat sink air 140 may enter the one or more exhaust channels form the second end 272 of the plate assembly. The second flow of heat sink air 140 may absorb heat from the flow of process air 120A as it proceeds through the conditioning channel, and may exit the exhaust channel as at least part of the flow of exhaust air 158. For instance, the second flow of heat sink air 140 may at least partially mix (e.g., combine), within the exhaust channel, with the first flow of heat sink air 130A, and the at least partially mixed heat sink flows may exit the exhaust channel as the flow of exhaust air 158.

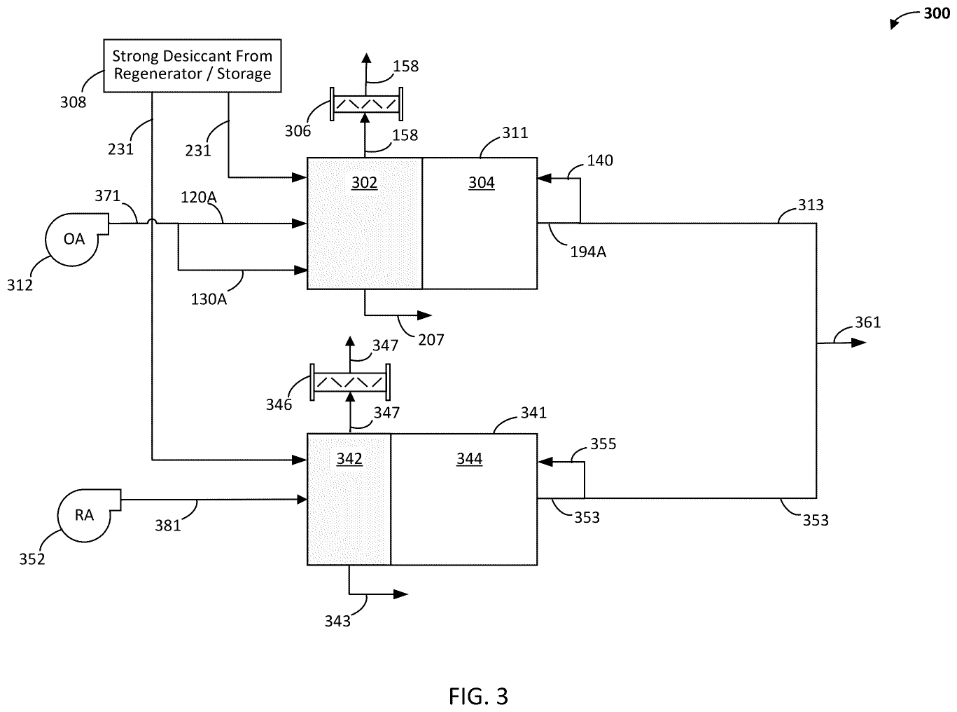

FIG. 3 illustrates a liquid desiccant air conditioning (LDAC) system 300 that includes a first plate assembly 311 and a second plate assembly 341. The first plate assembly 311 includes a dehumidification stage 302 and a cooling stage 304. Likewise, the second plate assembly 341 includes a dehumidification stage 342 and a cooling stage 344. Each of the first plate assembly 311 and the second plate assembly 341 include a plurality of plates defining a plurality of conditioning channels and a plurality of exhaust channels. For example, one or more of the first plate assembly 311 and the second plate assembly 341 may be the plate assembly 100 of FIG. 1 or the plate assembly 200 of FIG. 2. In some instances, one or more of the first plate assembly 311 and the second plate assembly 341 (e.g., the first plate assembly 311) may include heat sink air openings (e.g., such as the first heat sink air opening 152), and one or more of the first plate assembly 311 and the second plate assembly 341 (e.g., the second plate assembly 341) may not include the heat sink air openings 152. LDAC system 300 further includes an outside air fan 312 (e.g., a blower), a return air fan 352, a first control damper 306, and a second control damper 346.

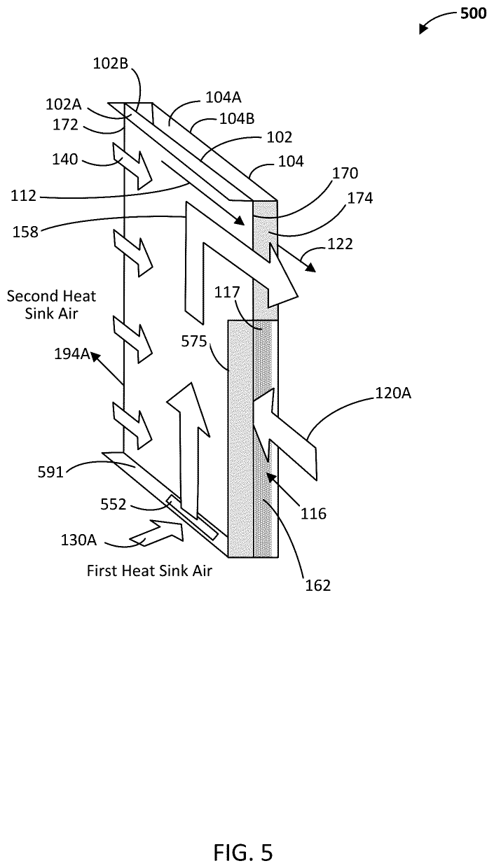

In some embodiments, the first plate assembly, which is fed outside air (OA), would have a plate assembly with a first heat sink air opening 152 (e.g., FIG. 1 or FIG. 5), while the second plate assembly 341, which is fed recirculated air (RA), would be a plate assembly like to FIG. 1, but without the heat sink air openings 152.

As illustrated, the outside air fan 312 may provide (e.g., blow) a flow of outside air 371 which is bifurcated into a first flow of process air 120A and a first flow of heat sink air 130A. For instance, the first flow of heat sink air 130A is a portion of the flow of outside air 371. The first flow of process air 120A enters the conditioning channels of the first plate assembly 311 and, as it proceeds through the dehumidification stage 302 of the conditioning channels, is dehumidified. For example, as illustrated, the first plate assembly 311 may receive a heat transfer fluid, such as concentrated liquid desiccant 231, from a regenerator 308. The first plate assembly 311 may provide the concentrated liquid desiccant 231 to wicking material that is positioned along the sides of the conditioning channels. The concentrated liquid desiccant 231 may proceed down through the wicking material thereby dehumidifying the first flow of process air 120A as it passes through the dehumidification stage 302 of the conditioning channels. The first plate assembly 311 may collect the diluted liquid desiccant 207, and provide the diluted liquid desiccant 207 back for re-concentration.

After proceeding through the dehumidification stage 302, the first flow of process air 120A proceeds through the cooling stage 304 of the conditioning channels and exits the conditioning channels as a first flow of supply air 194A.

The exhaust channels of the first plate assembly 311 may receive the first flow of heat sink air 130A. Because the exhaust channels are adjacent the conditioning channels, the first flow of heat sink air 130A can absorb heat from the first flow of process air 120A as it passes through the conditioning channels. The first flow of heat sink air 130A may proceed through the exhaust channels and exit the exhaust channels as a first flow of exhaust air 158. The first flow of exhaust air 158 may proceed through the first control damper 306 before exiting out to, for instance, an outside environment.

In some examples, a portion of the first flow of supply air 194A is provided to the exhaust channels as a second flow of heat sink air 140. In some instances, the second flow of heat sink air 140 may mix (e.g., combine) with at least portions of the first flow of heat sink air 130A, and the mixed heat sink air flows may exit the exhaust channels as the first flow of exhaust air 158. As such, the second flow of heat sink air 140 may, in addition to or alternate to the first flow of heat sink air 130A, absorb heat from the first flow of process air 120A as it passes through the conditioning channels.

As further illustrated in FIG. 3, the return air fan 352 may provide (e.g., blow) return air (e.g., return air from a building) as a second flow of process air 381 that enters the conditioning channels of the second plate assembly 341. The second flow of process air 381 proceeds through the dehumidification stage 342 of the conditioning channels and is dehumidified. For example, the second plate assembly 341 may receive concentrated liquid desiccant 231 from the regenerator 308, and may provide the concentrated liquid desiccant 231 to wicking material that is positioned along the sides of the conditioning channels. The concentrated liquid desiccant 231 may proceed down through the wicking material thereby dehumidifying the second flow of process air 381 as it passes through the dehumidification stage 342 of the conditioning channels. The second plate assembly 341 may collect the diluted liquid desiccant 343, and provide the diluted liquid desiccant 343 back for re-concentration.

After proceeding through the dehumidification stage 342, the second flow of process air 381 proceeds through the cooling stage 344 of the conditioning channels and exits the conditioning channels as a second flow of supply air 353.

In some examples, a portion of the second flow of supply air 353 is provided to the exhaust channels as a flow of heat sink air 355. As such, the flow of heat sink air 355 may absorb heat from the second flow of process air 381 as it passes through the conditioning channels.

Notably, in this example, a portion of the second flow of process air 381 is not provided as heat sink air into the exhaust channels through the heat sink openings 152 (e.g., as is done with the first flow of heat sink air 130A into the exhaust channels of the first plate assembly 311). This may provide benefits when the second flow of process air 381 is based on return air. In some examples, a portion of the second flow of process air 381 is provided as heat sink air into the exhaust channels. The portion of the second flow of process air 381 that is provided as heat sink air into the exhaust channels of the second plate assembly 341 can differ from the portion of the flow of outside air 371 that is provided as the first flow of heat sink air 130A into the exhaust channels of the first plate assembly 311.

The first flow of supply air 194A and the second flow of supply air 353 may be provided as a combined flow of supply air 361. For example, the first flow of supply air 194A may mix with the second flow of supply air 353, and the mixed flows of processed air may be provided as the combined flow of supply air 361. The combined flow of supply air 361 may be provided to a building, for example.

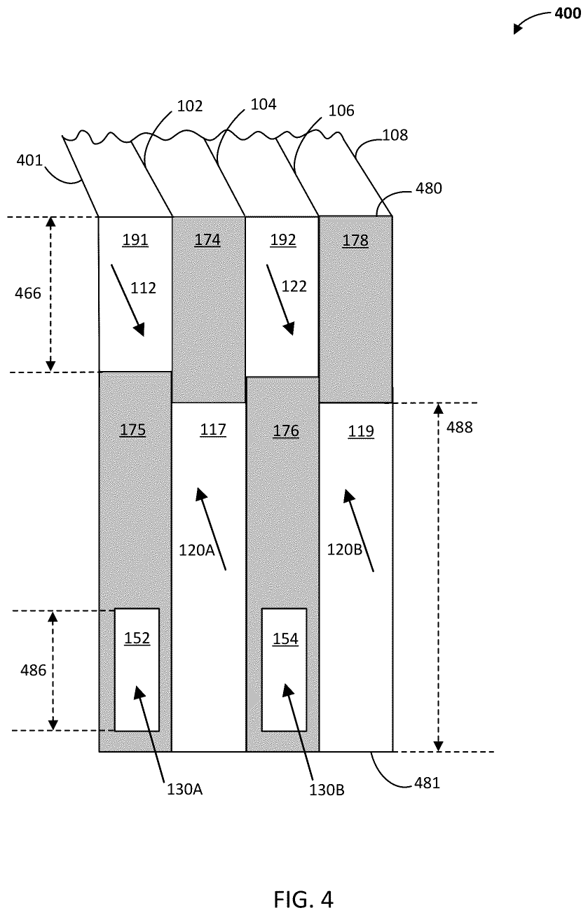

FIG. 4 illustrates portions of a plate assembly 400 from an end view. In this example, plate assembly 400 includes a first plate 102, a second plate 104, a third plate 106, a fourth plate 108, and a fifth plate 401. The fifth plate 401 and the first plate 102 define a first exhaust channel 112, while the first plate 102 and the second plate 104 define a first conditioning channel 120A. Similarly, the second plate 104 and the third plate 106 define a second exhaust channel 122, while the third plate 106 and the fourth plate 108 define a second conditioning channel 120B.

As illustrated, a first exhaust channel opening 191 of the first exhaust channel 112 is adjacent a first end 480 (e.g., upper end) of the plate assembly 400. The first exhaust channel opening 191 extends from the first end 480 to a first exhaust channel barrier 175. In addition, a first conditioning channel opening 117 of the first conditioning channel 120A is adjacent a second end 481 (e.g., lower end) of the plate assembly. The first conditioning channel opening 117 extends from a first conditioning channel barrier 174 to the second end 481 of the plate assembly 400.

Similarly, a second exhaust channel opening 192 of the second exhaust channel 122 is adjacent the first end 480 of the plate assembly 400. The second exhaust channel opening 192 extends from the first end 480 to a second exhaust channel barrier 176. In addition, a second conditioning channel opening 119 of the second conditioning channel 120B is adjacent the second end 481 of the plate assembly 400. The second conditioning channel opening 119 extends from a second conditioning channel barrier 178 to the second end 481 of the plate assembly 400.

In some examples, any of the first conditioning channel opening 117 and second conditioning channel opening 119 may have a conditioning channel opening height 488 in the range of 50% to 85% (e.g., 50% to 65%, 65% to 80%, 70% to 80%) of the distance between the first end 480 and second end 481 of the plate assembly 400. For instance, any of the first conditioning channel opening 117 and second conditioning channel opening 119 may have a conditioning channel opening height 488 that is at least 50% of the distance between the first end 480 and second end 481 of the plate assembly 400. In some examples, any of the first conditioning channel opening 117 and second conditioning channel opening 119 may have a conditioning channel opening height 488 that is 75% of the distance between the first end 480 and second end 481 of the plate assembly 400. Although, as in this example, the first conditioning channel opening 117 and second conditioning channel opening 119 begin from the second end 481 of the plate assembly 400, in other examples, any of the first conditioning channel opening 117 and second conditioning channel opening 119 can begin anywhere from the second end 481 of the plate assembly 400 to the first end 480 of the plate assembly.

In some examples, any of the first exhaust channel opening 191 and second exhaust channel opening 192 may have an exhaust channel opening height 466 in the range of 10% to 50% (e.g., 10% to 45%, 20% to 40%, 25% to 50%) of the distance between the first end 480 and second end 481 of the plate assembly 400. For instance, any of the first exhaust channel opening 191 and second exhaust channel opening 192 may have an exhaust channel opening height 466 that is at most 50% of the distance between the first end 480 and second end 481 of the plate assembly 400. In some examples, any of the first exhaust channel opening 191 and second exhaust channel opening 192 may have exhaust channel opening height 466 that is 25% of the distance between the first end 480 and second end 481 of the plate assembly 400. Although, as in this example, the first exhaust channel opening 191 and second exhaust channel opening 192 begin from the first end 480 of the plate assembly 400, in other examples, any of the first exhaust channel opening 191 and second exhaust channel opening 192 can begin anywhere from the first end 480 of the plate assembly 400 to the second end 481 of the plate assembly.

Further, as illustrated, the first exhaust channel barrier 175 may include a first heat sink air opening 152 into the first exhaust channel 112 for a first flow of heat sink air 130A. Similarly, the second exhaust channel barrier 176 may include a second heat sink air opening 154 into the second exhaust channel 122 for a second flow of heat sink air 130B. In some examples, a heat sink air opening height 486 of any of the first heat sink air opening 152 and second heat sink air opening 154 may be in the range of 10% to 50% (e.g., 20% to 40%) of the distance between the first end 480 and second end 481 of the plate assembly.

FIG. 5 illustrates a plate assembly 500 that includes a first plate 102 and a second plate 104. A first side 102A of the first plate 102 defines a first side of a first exhaust channel 112, and a second side 102B of the first plate 102 defines a first side of a conditioning channel 116. Further, a first side 104A of the second plate 104 defines a second side of the conditioning channel 116, and a second side 104B of the second plate 104 defines a first side of a second exhaust channel 122.

In this example, at least a portion of a flow of process air 120A is received into the conditioning channel 116 at a first end 170 of the plate assembly 500. The flow of process air 120 may be, for example, outside air. Specifically, the first flow of process air 120A may be received into a process air opening 117 of the plate assembly 500. The process air opening 117 may be defined, at least in part, by the second side 102B of the first plate 102, the first side 104A of the second plate 104, and a process air barrier 174. The flow of process air 120A may be dehumidified and/or cooled as it proceeds through the conditioning channel 116. The dehumidified and cooled air may exit the conditioning channel 116 at a second end 172 of the plate assembly 500 as supply air 194A. The first supply air 194A may be provided, for example, to a building.

In addition, a first flow of heat sink air 130A is received into the first exhaust channel 112. More specifically, the first flow of heat sink air 130A is received into a first heat sink air opening 552 of a bottom barrier 591 of the plate assembly 500. The first flow of heat sink air 130A may be, for example, a flow of outside air. As illustrated, the first flow of heat sink air 130A enters the exhaust channel 112 from a bottom end 591 of the plate assembly 500, and may assist in absorbing heat from the conditioning channel 116. After proceeding through at least portions of the exhaust channel 112, the first flow of heat sink air 130A may form at least part of a flow of exhaust air 158 that exits the exhaust channel 112 at the first end 170 of the plate assembly 500 through an opening defined at least in part by exhaust air barrier 575. As will be understood, this flow arrangement of heat sink air may function similarly to the arrangement in FIG. 1 by providing heat sink air to the first end 170 of the plate assembly.

As illustrated, in some instances, a second flow of heat sink air 152 enters the first exhaust channel 112 from the second end 172 of the plate assembly 100. The second flow of heat sink air 140 may be a portion of the first supply air 594 exiting the conditioning channel 116. In some instances, the second flow of heat sink air 140 mixes (e.g., combines) with the first flow of heat sink air 130A. As such, the mixed flows may remove heat from the conditioning channel 116, and may exit the first exhaust channel 112 as the flow of exhaust air 158.

Among other advantages, the embodiments can provide for one or more flows of heat sink air into one or more exhaust channels of the plate assembly that allow for additional cooling of process air that proceeds through the conditioning channels of the plate assembly. For instance, in some examples, a plate assembly includes a first side that is opposite to a second side. The first side defines a side of a conditioning channel, while the second side defines a side of an exhaust channel. A first fluid flow, such as a flow of process air, may enter the conditioning channel from a first end of the plate assembly, and a flow of conditioned air may exit the conditioning channel from a second end of the plate assembly. Further, a flow of heat sink air, which can be a portion of the flow of conditioned air and/or a portion of process air, enters the exhaust channel, and a flow of exhaust air exits the exhaust channel. For instance, in some examples, the plate assembly bifurcates a flow of outside air to provide the flow of process air and the flow of heat sink air. In addition, in some examples, the flow of heat sink air enters the exhaust channel from the first end of the plate assembly. Additionally or alternatively, in some examples, at least a portion of the flow of conditioned air exiting the conditioning channel enters the exhaust channel as a flow of heat sink air. This flow of heat sink air may enter the exhaust channel from the second end of the plate assembly. Further, in some examples, the flow of exhaust air may exit the exhaust channel from the first end of the plate assembly.

The various embodiments described above are provided by way of illustration only and should not be construed to limit the claims attached hereto. Those skilled in the art will readily recognize various modifications and changes that may be made without following the example embodiments and applications illustrated and described herein, and without departing from the spirit and scope of the following claims.

What is claimed is:

1. A plate assembly, comprising:
a first plate comprising:
a first side defining a side of a conditioning channel, the conditioning channel configured to receive a flow of process air from a first end of the plate assembly and output a flow of conditioned air from a second end of the plate assembly; and
a second side, opposite the first side, defining a side of an exhaust channel, the exhaust channel configured to receive a flow of heat sink air and at least a portion of the flow of conditioned air, and output a flow of exhaust air.

2. The plate assembly of claim 1, wherein the exhaust channel is configured to receive the flow of heat sink air from the first end of the plate assembly.

3. The plate assembly of claim 1, wherein the flow of heat sink air includes at least a portion of the flow of process air

4. The plate assembly of claim 1, wherein the exhaust channel is configured to receive the portion of the flow of conditioned air from the second end of the plate assembly.

5. The plate assembly of claim 1, wherein the exhaust channel is configured to output the flow of exhaust air from the first end of the plate assembly.

6. The plate assembly of claim 1, wherein the flow of process air is opposite the flow of exhaust air at the first end of the plate assembly.

7. The plate assembly of claim 1, wherein the exhaust channel is configured to receive the flow of heat sink air from the second end of the plate assembly.

8. The plate assembly of claim 1, wherein the conditioning channel is configured to receive the flow of process air from at least a half of the first side of the first plate.

9. The plate assembly of claim 1, wherein the exhaust channel is configured to output the flow of exhaust air from at most a half of the second side of the first plate.

10. The plate assembly of claim 1, wherein the first side of the first plate is configured to receive desiccant to dehumidify the flow of process air.

11. The plate assembly of claim 1, wherein the conditioning channel is configured to receive the flow of process air from an outside air inlet.

12. An apparatus comprising:
a first plate assembly comprising a first plate, the first plate comprising:
a first side defining a side of a first conditioning channel, the first conditioning channel configured to receive a first flow of process air from a first end of the first plate assembly, and output a first flow of conditioned air from a second end of the first plate assembly, wherein the first plate assembly is configured to output a first portion of the first flow of conditioned air as supply air to a building; and
a second side, opposite the first side, defining a side of a first exhaust channel, the first exhaust channel configured to receive a first flow of heat sink air and at least a second portion of the flow of conditioned air, and output a first flow of exhaust air; and
a second plate assembly comprising a second plate, the second plate comprising:
a first side defining a side of a second conditioning channel, the second conditioning channel configured to receive a second flow of process air and output a second flow of conditioned air; and
a second side, opposite the first side, defining a side of a second exhaust channel.

13. The apparatus of claim 12, wherein the second exhaust channel is configured to receive a second flow of heat sink air and at least a portion of the second flow of conditioned air and output a second flow of exhaust air.

14. The apparatus of claim 13, wherein a first flow rate of the first flow of heat sink air is greater than a second flow rate of the second flow of heat sink air.

15. The apparatus of claim 13, wherein the second flow of heat sink air includes at least a portion of return air from the building.

16. The apparatus of claim 12, wherein the second conditioning channel is configured to:
receive return air from a first end of the second plate assembly; and
output the second flow of conditioned air from a second end of the second plate assembly.

17. The apparatus of claim 12, wherein the second conditioning channel is configured to output the second flow of conditioned air as a portion of the supply air to the building.

18. The apparatus of claim 12, wherein the first exhaust channel is configured to receive the first flow of heat sink air from the first end of the first plate assembly.

19. The apparatus of claim 12, wherein the first flow of heat sink air includes at least a portion of the first flow of process air.

20. The apparatus of claim 12, wherein the first side of the first plate is configured to receive desiccant to dehumidify the first flow of process air.

21. The apparatus of claim 12, wherein the first side of the second plate is configured to receive desiccant to dehumidify the second flow of process air.

22. The apparatus of claim 12, wherein the first conditioning channel is configured to receive the first flow of process air from an outside air inlet.
